(19) United States
(12) Patent Application Publication
(10) Pub. No.: US 2011/0238335 A1
(43) Pub. Date: Sep. 29, 2011

(54) COMPONENT BALANCING ON A CNC MACHINING CENTER

(76) Inventors: Jeffry D. Sharp, Brighton, MI (US); Nitin Chaphalkar, Schaumburg, IL (US); Tomohiko Hayashi, Mount Prospect, IL (US); Gregory Aaron Hyatt, South Barrington, IL (US)

(21) Appl. No.: 13/062,539

(22) PCT Filed: Sep. 4, 2009
(86) PCT No.: PCT/US2009/056081

§ 371 Date: Jun. 1, 2011

Related U.S. Application Data
(60) Provisional application No. 61/094,893, filed on Sep. 6, 2008.

(51) Int. Cl. G01M 1/22

(52) U.S. Cl. 702/56

(57) ABSTRACT

The present invention broadly comprises a method of establishing parameters of a balancer to predict part unbalance on a computer numerically controlled machine comprising the steps of varying unbalance of the balancer and measuring vibration to develop influence parameters of the balancer, varying unbalance of a test part and measuring vibration to develop influence parameters of the test part, comparing the influence parameters of the balancer and the test part, and, determining a range of test part unbalance over which the influence parameters of the balancer and the test part approximately match. The present invention also broadly comprises a system for machining and balancing a workpiece comprising a computer numerically controlled machine, and, a rotating balancer assembly arranged to determine a measurement of unbalance when a first initial vibration measured by a first vibration sensor exceeds a limited range of vibration sensed by the first vibration sensor.

### CROSS-REFERENCE TO RELATED APPLICATIONS

The present application claims priority to U.S. Provisional Application Ser. No. 61/094,893 filed Sep. 6, 2008, and which is incorporated herein by reference.

### TECHNICAL FIELD OF THE INVENTION

The present invention relates to computer numerically controlled machines and more particularly, to computer numerically controlled machines having a balancer system.

### BRIEF SUMMARY OF THE INVENTION

In an embodiment of the invention, the invention provides for balancing of a workpiece using a high sensitivity vibration sensor having a limited vibration measurement range. The magnitude and location of an unbalance in a workpiece can be determined when the vibration from the unbalance is greater than the limited range of the high sensitivity vibration sensor by way of a balancer system. If the vibration from the unbalance is less than the limited range, then the vibration sensor measurement can be used to determine the magnitude and location of the unbalance in a workpiece.

In an embodiment of the invention, the invention comprises a system for machining and balancing a workpiece comprising a computer numerically controlled machine having multiple axes for relatively moving a machining tool with respect to a workpiece. A first computer control system is operatively coupled to the computer numerically controlled machine. The first computer control system includes a computer readable medium having disposed thereon code for algorithmically determining processing parameters effective for compound machining of a workpiece using a tool given a preselected processing parameter for the compound machining. The system also includes a first vibration sensor arranged for sensing a limited range of vibration magnitudes to a desired accuracy. A rotating balancer assembly is mounted between a flange and a chuck of the computer numerically controlled machine, and the rotating balancer assembly is arranged to determine a measurement of unbalance when a first initial vibration measured by the first vibration sensor exceeds the limited range of vibration sensed by the first vibration sensor.

In another embodiment of the invention, the invention includes a method of establishing parameters of a balancer to predict part unbalance on a computer numerically controlled machine. The method includes the steps of varying unbalance of the balancer and measuring vibration to develop influence parameters of the balancer, varying unbalance of a test part and measuring vibration to develop influence parameters of the test part, comparing the influence parameters of the balancer with the influence parameters of the test part, and determining a range of test part unbalance over which the influence parameters of the balancer approximately match the influence parameters of the test part.

In an embodiment of the invention, the method further includes the step of determining a plurality of spindle speeds within an operating range of the computer numerically controlled machine at which the spindle has a high vibration response. A spindle speed may be identified at which the influence parameters of the balancer better match the influence parameters of the test part.

The method may further include comparing the influence parameters of the balancer with the influence parameters of the test part at the plurality of spindle speeds.

In yet another embodiment of the invention, the invention includes a method of balancing a workpiece on a computer numerically controlled machine and balancer system comprising the steps of mounting the workpiece on a spindle of the computer numerically controlled machine, machining the workpiece on the computer numerically controlled machine, rotating the workpiece about a rotational axis of the spindle, using the spindle balancer to measure a magnitude and phase of an initial unbalance of the machined workpiece, further machining the machined workpiece on the computer numerically controlled machine to reduce the initial unbalance of the machined workpiece, measuring a vibration magnitude and phase of the spindle and further machined workpiece using a vibration sensor arranged for sensing a limited range of vibration magnitudes to a desired accuracy, converting the measure of the magnitude and phase of vibration of the spindle and further machined workpiece into a measurement of magnitude and phase of a residual unbalance of the further machined workpiece, and yet further machining the further machined workpiece on the computer numerically controlled machine to reduce the residual imbalance of the further machined workpiece.

The invention will now be described in detail in terms of the drawings and the description which follow.

### BRIEF DESCRIPTION OF THE SEVERAL VIEWS OF THE DRAWING(S)

FIG. 1 is a front elevation of a computer numerically controlled machine of the present invention, shown with safety doors closed.

FIG. 2 is a perspective view of certain interior components of the computer numerically controlled machine illustrated in FIG. 1, showing, among other things, a spindle and a first chuck.

FIG. 3 is a perspective view of a second spindle and a carriage assembly.

FIG. 4 is a perspective view of the first chuck and balancer system illustrated in FIG. 2, showing jaws of the first chuck holding a workpiece.

FIG. 5 is a cross-sectional view of the first chuck and balancer system.

FIG. 6 is a schematic view of the two counterweighted rotors of the balancer system.

FIG. 7 is a schematic view of the spindle and the first chuck showing positions of three accelerometers.

FIG. 8 is a diagram illustrating the communication lines between the computer numerically controlled machine and a controller of the balancer system.

FIG. 9 is a diagram further illustrating the communication lines between the computer numerically controlled machine and a controller of the balancer system.

FIG. 10 is a graph showing vibration levels at various spindle speeds using an unbalanced part and a 1000 mV/g accelerometer.

FIG. 11 is a graph showing vibration levels at various spindle speeds without an unbalanced part and with a 100 mV/g accelerometer.

FIG. 12 is a graph showing a comparison of the balancer sensitivity and component sensitivity influence coefficients at various unbalance levels.

FIG. 13 is a flow chart of a method of establishing parameters of a balancer to predict part unbalance on a computer numerically controlled machine.

FIG. 14 is a flow chart of a method of balancing a workpiece on a computer numerically controlled machine and balancer system.

### DETAILED DESCRIPTION OF THE INVENTION

At the outset, it should be appreciated that the use of the same reference number throughout the several figures designates a like or similar element.

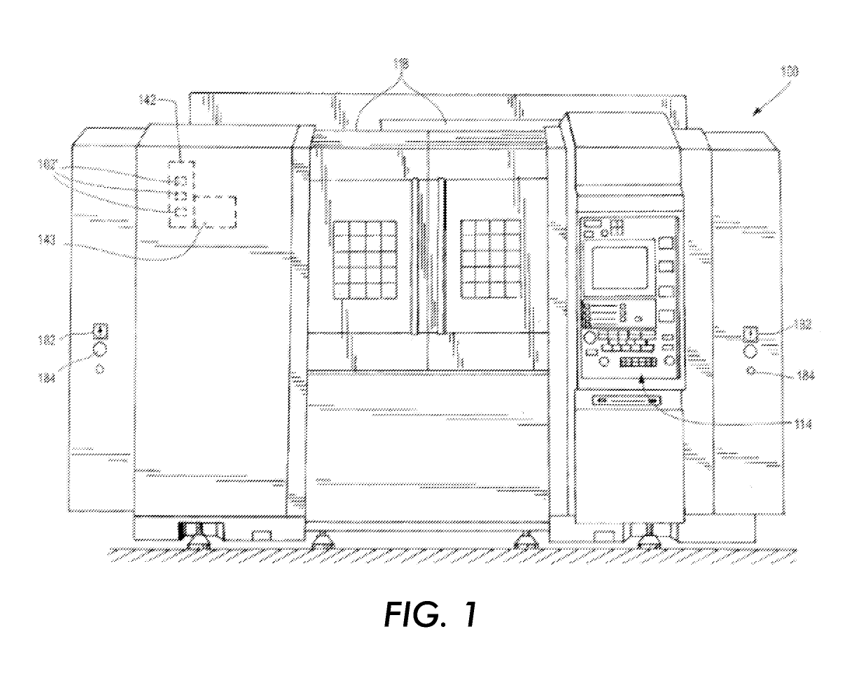

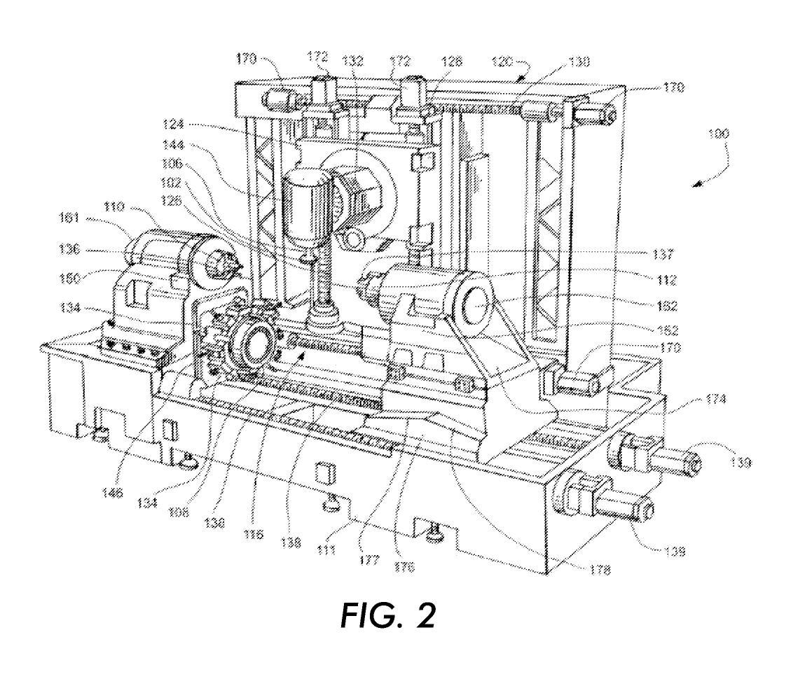

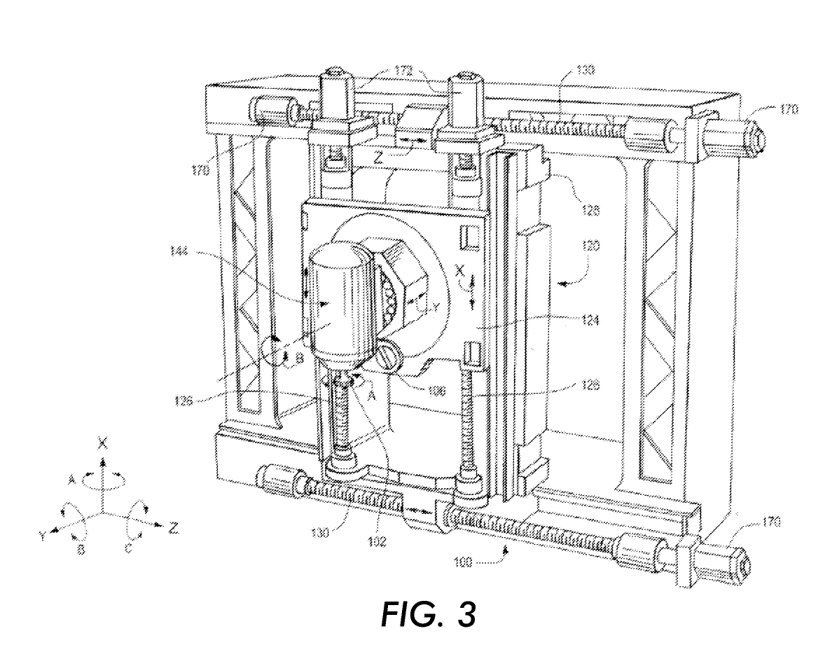

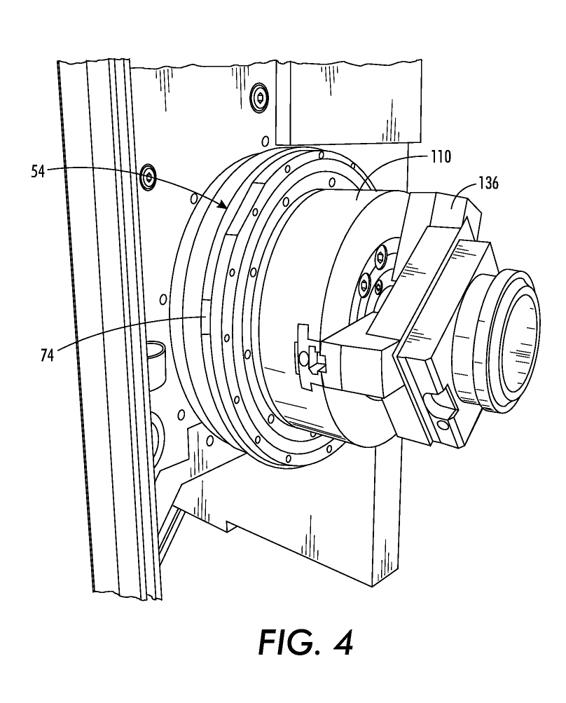

Referring now to the figures, FIGS. 1-5 show a computer numerically controlled machine 100 of the present invention, including a computer control system 114 for controlling the various instrumentalities within the computer numerically controlled machine 100. The computer numerically controlled machine 100 further includes a spindle housing 150 that is stationary with respect to a bed 111 of the computer numerically controlled machine 110, and a first chuck 110 provided with jaws 136. The first chuck 110 is concentrically engaged to the front end of a spindle 50 rotatably mounted within the spindle housing 150 via a plurality of bearings (not shown). The spindle housing 150 further includes a flange 52 for receiving a balancer system 54. The balancer system 54 includes a coil assembly 56 and a balancer assembly 58 as described in more detail below.

In an embodiment of the invention, the computer numerically controlled machine 100 includes a second chuck 112 with jaws 137. The second chuck 112 can be moveable with respect to the bed 111 of the computer numerically controlled machine 100.

In an embodiment of the invention, the computer numerically controlled machine 100 may also include safety doors 118 that can be opened to permit access to a machine chamber 116, which can include, among other things, a spindle 144, a turret 108, the first chuck 110, and a second chuck 112. It should be appreciated by those having ordinary skill in the art that these machining tool features are not all required and that the computer controlled machine 100 can include additional features as well.

The spindle 144 includes a tool holder 106 that retains a cutting tool 102. The tool holder 106 is coupled to the spindle 144 via a spindle connecter (not shown), which is known in the art. Any type of cutting tool suitable for the computer numerically controlled machine 100 can be used, including, but not limited to, milling tools, drilling tools, grinding tools, blade tools, broaching tools, and turning tools. The spindle 144 rotates the cutting tool 102 along the A-axis.

As shown in the figures, the spindle 144 is mounted on a carriage assembly 120 and a ram 132. The carriage assembly 120 permits translation of the spindle 144 along the X-axis and the Z-axis, while the ram 132 permits translation along the Y-axis. In an embodiment of the invention, the spindle 144 can also be rotated approximately 240 degrees along the B-axis. The translation and rotation of the spindle 144 as described herein is powered by motors of the computer numerically controlled machine 100.

In an embodiment of the present invention, the computer numerically controlled machine 100 further includes the turret 108, which includes a plurality of turret connectors 134 for securing tool holders 135 coupled to cutting tools 102. The turret 108 can have a variety of turret connectors 134 and tool holders 135 and therefore, the turret 108 can operate a variety of cutting tools 102. The turret 108 rotates along the C-axis thereby permitting the turret 108 to present different cutting tools 102 for cutting the workpiece.

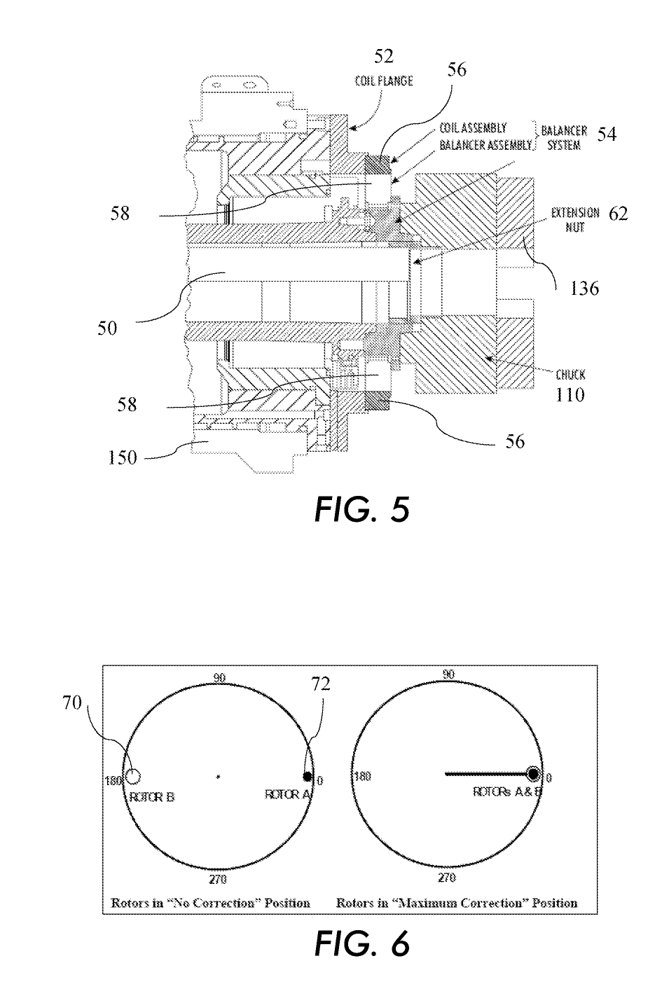

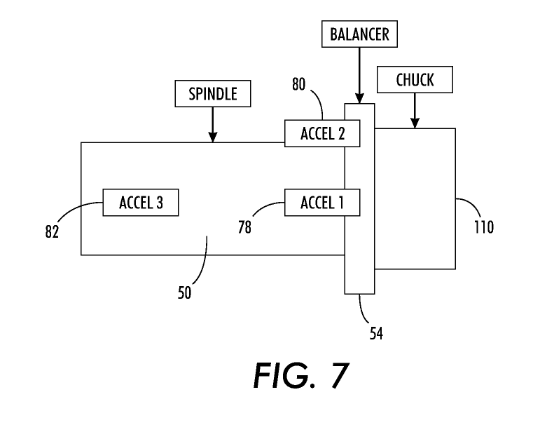

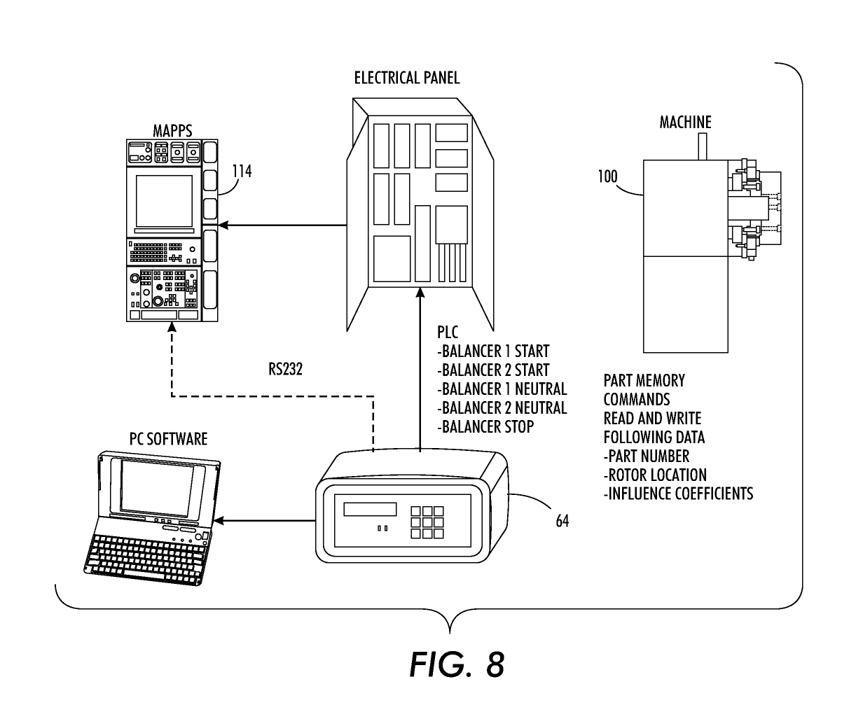

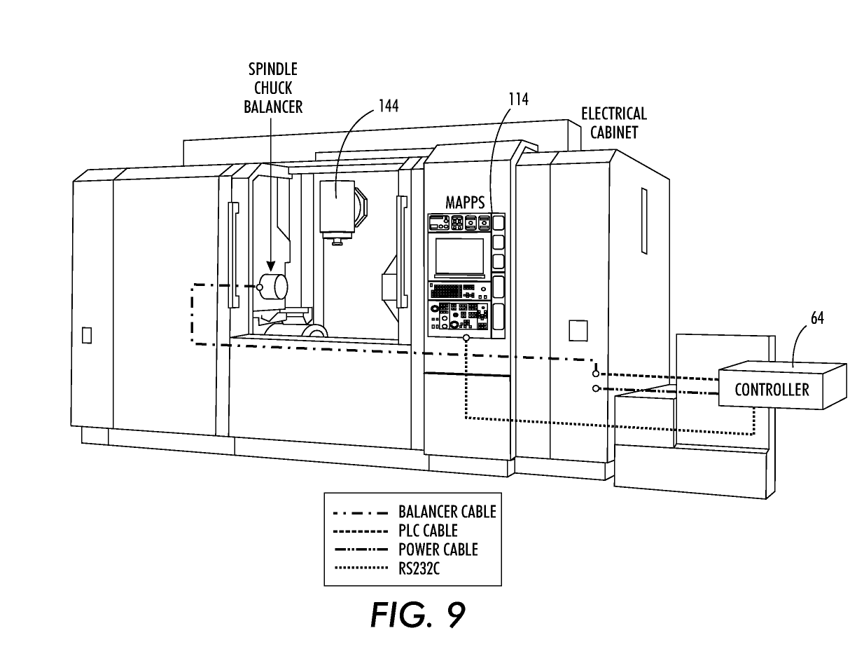

The first chuck 110 has jaws 136 that retain a workpiece to be machined and balanced. The first chuck 110 is concentrically engaged to the front end of a spindle 50 by way of a chuck adaptor 60 and an extension nut 62. The spindle 50 is rotatably mounted within the spindle housing 150 via a plurality of bearings (not shown). As shown in FIG. 5 the balancer system 54 is mounted to the spindle housing 150, wherein the coil assembly 56 of the balancer system 54, which is a stationary power coil assembly, is mounted to the flange 52, and the balancer assembly 58, which is a rotating actuator ring assembly, is mounted to the spindle 50. Referring to FIGS. 8 and 9, the balancer system 54 may include a controller 64 having a microprocessor acting and/or operating under stored program control and an electrical driver which is selectively coupled to the source of electrical power through the controller 64. The balancer assembly 58 includes two counterweighted, independently positionable rotors 70, 72, shown in FIG. 6. The rotors 70, 72 provide a maximum amount of balance correction when they are adjacent another, or zero degrees)(0°) apart, and no balance correction when they are opposite each other or one-hundred eight degrees (180°) apart. When the rotors 70, 72 are opposite each other in the zero degrees (0°) and one-hundred eighty degree (180°) positions, respectively, the rotors 70, 72 are considered to be in a “neutralized” position. The controller 64 is adapted to selectively couple electrical power to the balancer actuators and/or rotors 70, 72 to correct a measured and/or calculated unbalance condition. More specifically, power passes from the stationary coils in the coil assembly 56 to the balancer assembly 58 by inducing magnetic fields across an air gap causing the counterweighted rotors 70, 72 to shift positions. The balancer system 54 further includes a vibration sensor 74 which measures and communicates spindle vibration to the controller 64 and a position sensor 76, which communicates the counterweighted rotor 70, 72 positions to the controller 64. One reference signal is provided to the controller 64, which is used to determine the spindle speed and the phase reference. In an embodiment of the invention, the vibration sensor 74 is located at the chuck end of the spindle housing 150 in the direction in which vibration is to be controlled. In an embodiment of the invention, the vibration sensor 74 measures horizontal vibration. As shown in FIGS. 7 and 8, the controller 64 can communicate with the computer control system 114 by way of an RS232 serial communications port using a serial cable or by similar communication technologies known in the art. One example of a balancer system that can be used is the Lord Series 254 automatic balancer having a 51.4 oz-in, 37,000 gr-mm capacity.

Using the balancer system 54, a workpiece can be balanced without removing the workpiece from the computer numerically controlled machine 100 on which the workpiece is “machined” into a desirable shape, size, and/or geometry. It is desirable to remove unbalance of the machined workpiece because unbalance can cause the workpiece to perform imprecisely and undesirably. Any type of workpiece providing for balancing by material removal can be used, and, any type of material removal technique capable of being performed on a computer numerically controlled machine 100 can be used to correct unbalance of the workpiece. Workpiece machining and balancing can be achieved on any type of rigid computer numerically controlled machine when a highly sensitive vibration sensor is utilized.

In an embodiment of the invention, the balancer system 54 can include a lock for either enabling or disabling the balancer system's ability to determine a measurement of unbalance of the workpiece. That is, the computer numerically controlled machine 100 can include a balancer system for balancing the machine itself, which balancer system can optionally be enabled to allow the balancer system to also determine a measurement of unbalance of the workpiece. In an embodiment of the invention, a computer software program can be required to enable the balancer system to determine a measurement of unbalance of the workpiece. Without the computer software program, the balancer system is locked from determining a measurement of unbalance of the workpiece.

To balance a workpiece without removing it from the computer numerically controlled machine 100, balancer parameters must first be established and stored during a set-up process. These parameters are utilized to define data regarding the specific magnitude and location of material of unbalance in a workpiece, that is, the magnitude and location of material required to be removed to balance a workpiece. The data is communicated to the computer control system 114 and the computer numerically controlled machine 100 performs the necessary material removal operation to balance the workpiece. The process is reiterated, if necessary, until a predetermined residual unbalance in the workpiece is achieved. This improved and new computer numerically controlled machine 100 and balancer system 54 methodology is explained in further detail herebelow.

Before beginning workpiece balancing, vibration signature testing is conducted, wherein vibrational data throughout the operating speed (rpm) range of the computer numerically controlled machine 100 is obtained. Preferably, this vibrational data is measured by placing an unbalanced test part in the jaws 136 of the first chuck 110, rotating the spindle 50 at increasing speeds (rpm), and measuring the vibration (u-in). Alternatively, vibration signature testing can be conducted without a test part or with a balanced test part retained in the jaws 136 of the first chuck 110. The vibration is detected by the vibration sensor 74, which is preferably a 1000 mV/g accelerometer. A satisfactory accelerometer that can be used is a Wilcoxon 799M filtered low frequency accelerometer, which is commercially available from Wilcoxon Research, Inc. However, other types of accelerometers known in the art can be used and are intended to be within the spirit and scope of the invention as claimed. The vibrational data is used to determine at which speeds the computer numerically controlled machine's response to unbalance is the greatest. Preferably, two to three different speeds are chosen. It should be appreciated by those having ordinary skill in the art that the objective of vibration signature testing is to define speeds producing the greatest spindle vibration because turning and milling machines are typically rigid, producing only small amounts of vibration. Therefore, the higher vibration values provide more predicable data since the vibration values are above typical noise levels.

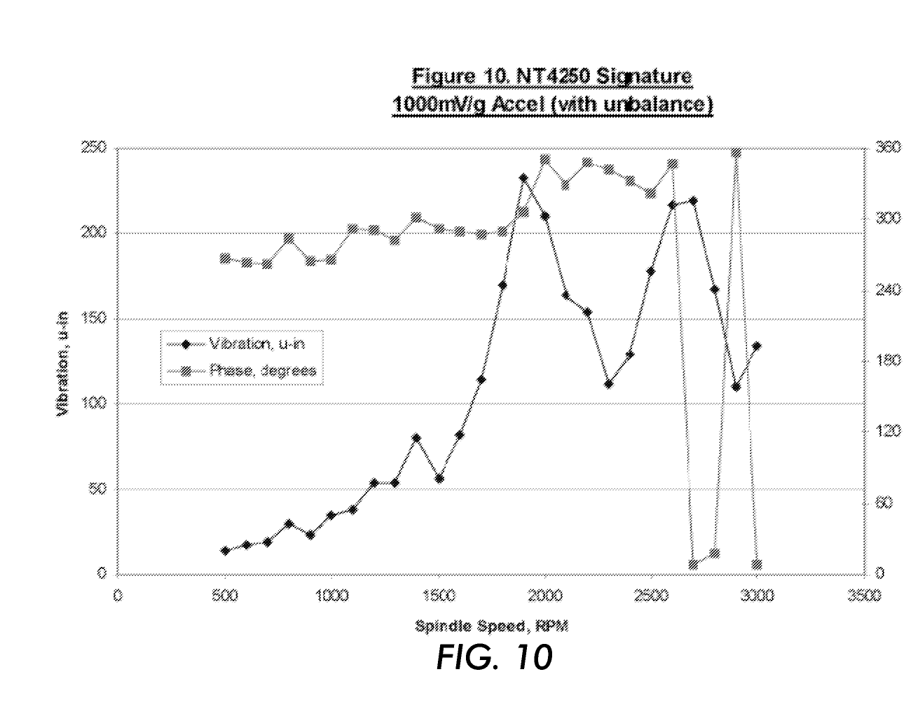

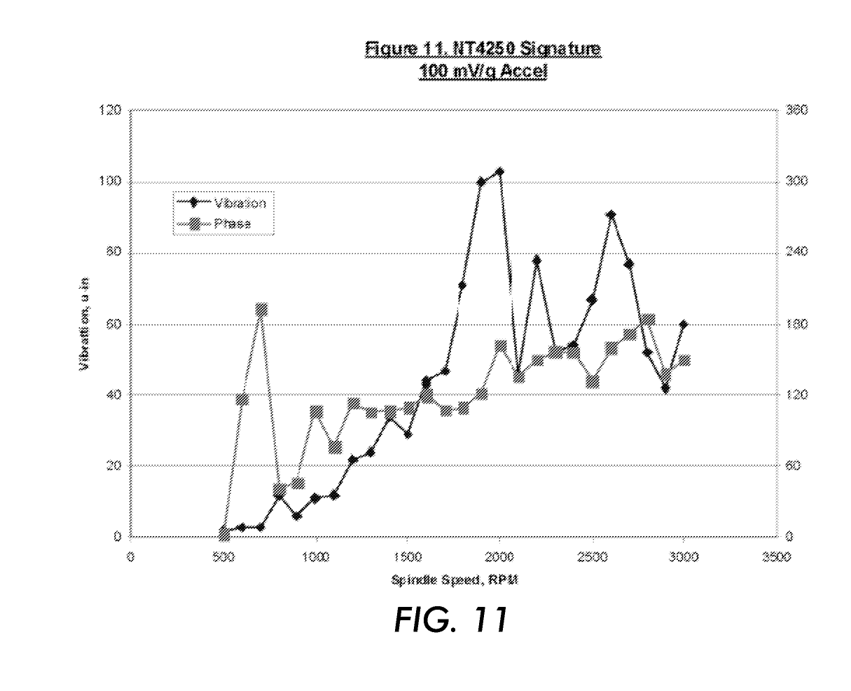

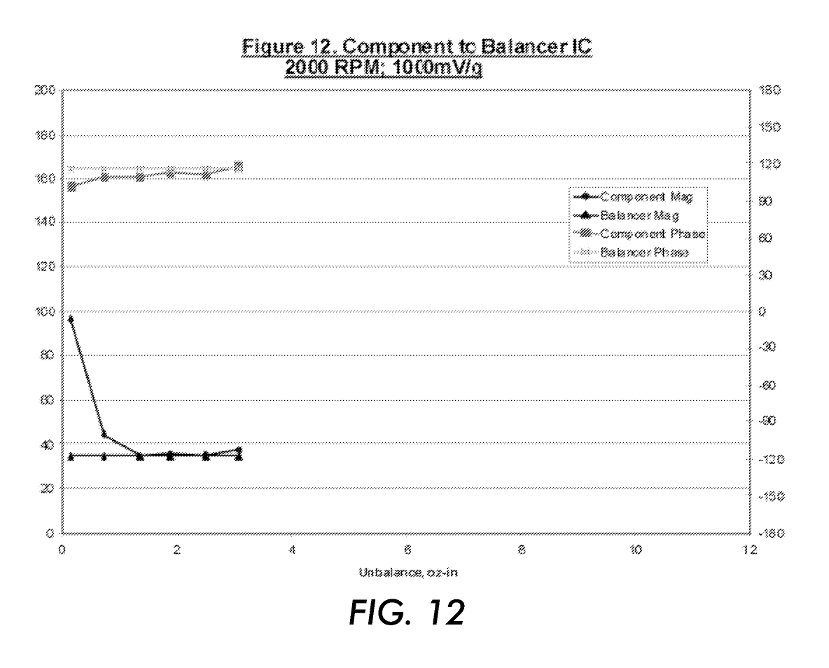

As shown in FIG. 10, results of vibration signature testing on a Mori Seiki NT 4250 turning/milling center using a 1000 mV/g accelerometer and a cylindrical, steel test part having an 150 mm outside diameter (OD), an 100 mm inside diameter (ID), and a length of approximately 200 mm showed the “highest sensitivity,” meaning the greatest amount of vibration with a linear relationship, at spindle speeds of approximately 2000 rpm and at 2600 rpm. Results of vibration signature testing using a 100 m V/g accelerometer without an unbalanced test part are shown if FIG. 11. While both figures show the same vibration response trend, the vibration levels in FIG. 10 are higher than the vibration levels in FIG. 11 as a result of the added unbalance to the system. Notwithstanding, both figures indicate that the highest sensitivity occurs at approximately 2000 rpm and 2600 rpm.

In an embodiment of the invention, the computer numerically controlled machine 100 can be tested with a control accelerometer 78 and two additional accelerometers 80, 82 positioned at different locations on the spindle housing 150, as shown in FIG. 7, to determine whether vibration measured at different locations on the spindle housing 150 increases as a result of rotation of the spindle 50 rotation and actuation of the balancer system 54. More specifically, accelerometers 78 and 80 were disposed approximately ninety (90°) degrees apart along the same plane, while accelerometer 82 was aligned with the accelerometer 78 at the opposite end of the spindle housing 150. A first set of vibrational measurements was recorded when the spindle 50 was rotated with the balancer system 54 neutralized. A second and third set of vibrational measurements were recorded by adding 6.4 oz-in and 12.8 oz-in of unbalance, respectively, by changing the position of the rotors 70, 72 in the balancer system 54. A fourth set of vibrational measurements was recorded with the balancer system 54 positioned to minimize the vibration at the first accelerometer 78. The vibrational measurements showed that vibration measured ninety (90°) degrees from the control accelerometer 78 or at the opposite end of the spindle housing 150 does not increase by actuation of the balancer or by spindle 50 vibration. Vibration measured at accelerometers 80 and 82 followed the same trend as vibration measured at accelerometer 78. It was therefore determined that a single accelerometer measuring vibration in the horizontal direction is sufficient to characterize the overall spindle 50 vibration for this particular computer numerically controlled machine 100.

Next, the sensitivity of the balancer system 54 and of the test part was determined. The high sensitivity speeds determined by way of the vibration signature testing described above were used to conduct the balancer system 54 and test part sensitivity tests described below.

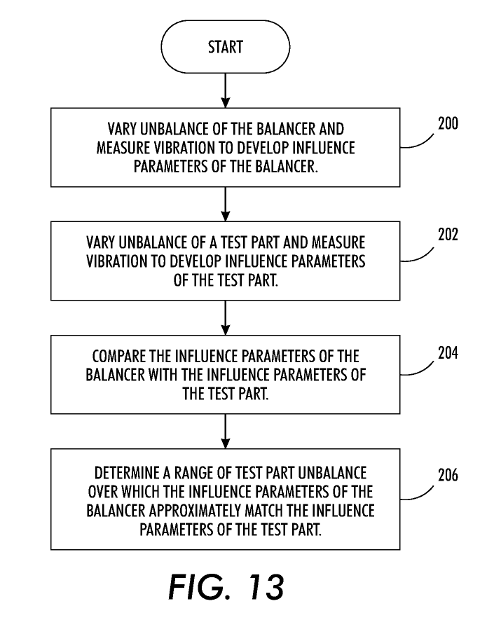

The balancer sensitivity was determined by varying the unbalance of the balancer system 54 and measuring vibration to develop influence parameters of the balancer system 54, according to step 200 of FIG. 13.

More specifically, to characterize the sensitivity of the balancer system 54, an unbalanced test part was placed in the jaws 136 of the first chuck 110. Then several “automatic balance cycles” were completed. By automatic balance cycle it is meant that the spindle 50 is rotated at the high sensitivity speeds determined during the vibration signature testing and the controller 64 calculates the counterweight rotor positions 70, 72 estimated to minimize the vibration measured by the vibration sensor 74 and sends power pulses to move the counterweight rotors 70, 72 from a neutral position to these positions. The controller 64 then calculates an influence coefficient, which can be thought of as a measure of the computer numerically controlled machine's response to an unbalance, based on the known unbalance as determined by the counterweight rotor 70, 72 positions. That is, the influence coefficient is a function of the rotor position and the speed of rotation and is computed using the following equation:

C=(v₁−v₂)/(w₁−w₂)

where C is the influence coefficient, w₁ is a first unbalance of the balancer provided by the rotor positions and v₁ is the corresponding vibration, and where w₂ is a second unbalance of the balancer provided by the rotor positions and v₂ is the corresponding vibration.

As stated above, during the characterization of sensitivity of the balancer system 54, several automatic balance cycles are completed. After the first automatic balance cycle, the influence coefficient C is calculated and stored. Then a second automatic balance cycle is completed and a new influence coefficient C is computed. The weighted average of the first and second influence coefficients C is calculated and stored in the memory of the controller 64. Automatic balance cycles are continued until the weighted average of the stored influence coefficient C is the same or almost the same as the most recent influence coefficient C measurement. This process was repeated by varying the unbalance levels, wherein the positions of the counterweighted rotors 70, 72 were changed to obtain influence coefficient C measurements at such unbalance levels.

The sensitivity of the test part is determined by varying the unbalance of a test part and measuring the vibration to develop influence parameters of the test part, according to step 202 of FIG. 13. More specifically, incrementally deeper holes are drilled into the test part until a depth of 36 mm is reached. For example, the hole can be drilled at 6 mm, 12 mm, 18 mm, 24 mm, 30 mm and 36 mm. Between each drilling, the spindle 50 was rotated at the high sensitivity speeds determined from the vibration signature testing, for example 2000 rpm and 2600 rpm in the example above, and the resulting vibration measured by the vibration sensor 74 was recorded. A second hole was incrementally drilled 180 degrees away from the first hole at identical depths and the resulting vibration from each incremental drilling was measured by the vibration sensor 74 and recorded. Thus, two data points at each of the unbalance levels were obtained.

Typically a hole is drilled into a test part at a predetermined pitch radius because that is the position of the material that can be removed. Further, the hole diameter is generally predetermined, and the material weight density and hole depth is known. Therefore, the unbalance in the test part can be computed as follows:

ME=(π/4)(D_{H}²*L*R_{pitch}* [symbol] )

where ME is the unbalance of the component, D_{H} is the hole diameter, L is the hole depth, R_{pitch} is the pitch radius, and [symbol] is the material weight density.

This calculated ME value, or unbalance of the component, can be used to compute an influence coefficient for each unbalance level caused by the incremental drilling of the various holes using the following equation:

C=V−V_{b}/ME

where V is the vibration value measured at a specific unbalance level, V_{b} is the baseline vibration value and C is the influence coefficient.

That is, the baseline vibration (V_{b}) was measured via the vibration sensor 74 using a test part, which has no material removed, mounted in the chuck 110. The baseline vibration was subtracted from the total vibration (V), which was measured with a test part mounted in the chuck 110, the test part having incrementally deeper holes to provide unbalance levels. This net vibration value was divided by the known unbalance of the component (ME) to determine an influence coefficient at each unbalance level.

Three higher unbalances levels were tested by drilling two holes, 36 mm deep, at a position of twenty degrees (20°) to either side of the first hole (5.77 oz-in; 4153 gr-mm). Two more holes having a depth of 18 mm were drilled forty degrees (40°) to either side of the first hole (7.78 oz-in; 5599 gr-mm). Finally, the 18 mm holes at forty degrees)(40° were drilled to a depth of 36 mm (10.47 oz-in; 7539 gr-mm).

The influence coefficients C from the balancer system 54 sensitivity testing and the test part sensitivity testing obtained at each high sensitivity speed are compared, as depicted in step 204 of FIG. 13. For instance, according to the example described above, the influence coefficients C of the balancer system 54 at 2000 rpm and 2600 rpm are compared to the influence coefficients C of the test part at 2000 rpm and 2600 rpm, respectively. As shown in FIG. 13, for the example described above, the magnitude of the influence coefficients measured at 2000 rpm for the test part and the balancer are within seven percent (7%) and the phase of the influence coefficients are within six percent (6%) at unbalance levels greater than 1.35 oz-in (944 gr-mm). The influence coefficients measured at 2600 rpm for the test part and the balancer did not correlate as well. Therefore, it was determined, according to step 206, that workpiece balancing for this example should preferably be conducted at the speed of 2000 rpm and the magnitude and phase of the balancer influence coefficient at 2000 rpm is the preferred influence coefficient to use for calculating residual unbalance in the test part having the incrementally deeper holes drilled therein. Further, it was determined that, for purposes of predictability, unbalance levels as low as 1.35 oz-in could be measured accurately.

Thus, the set up conducted, as described above, to establish parameters of a balancer system 54 to predict workpiece unbalance on a computer numerically controlled machine 100 showed that unbalance in a workpiece can be predicted using data from the automatic balancer controller. For the example described above, the predications are optimal when the computer numerically controlled machine 100 was operated at 2000 rpm using a 1000 mV/g accelerometer. Determining the speed and unbalance level where the influence coefficients correlate is preferable because it allows for use of a high sensitivity vibration sensor and for the unbalance of a workpiece to be determined regardless of whether the vibration from the unbalance is greater than the limited range of the high sensitivity vibration sensor. That is, if the vibration from the unbalance is greater than the limited range, the balancer system 54 can be used to determine the magnitude and location of the unbalance in a workpiece. If the vibration from the unbalance is less than the limited range, then the vibration sensor measurement can be used to determine the magnitude and location of the unbalance in a workpiece.

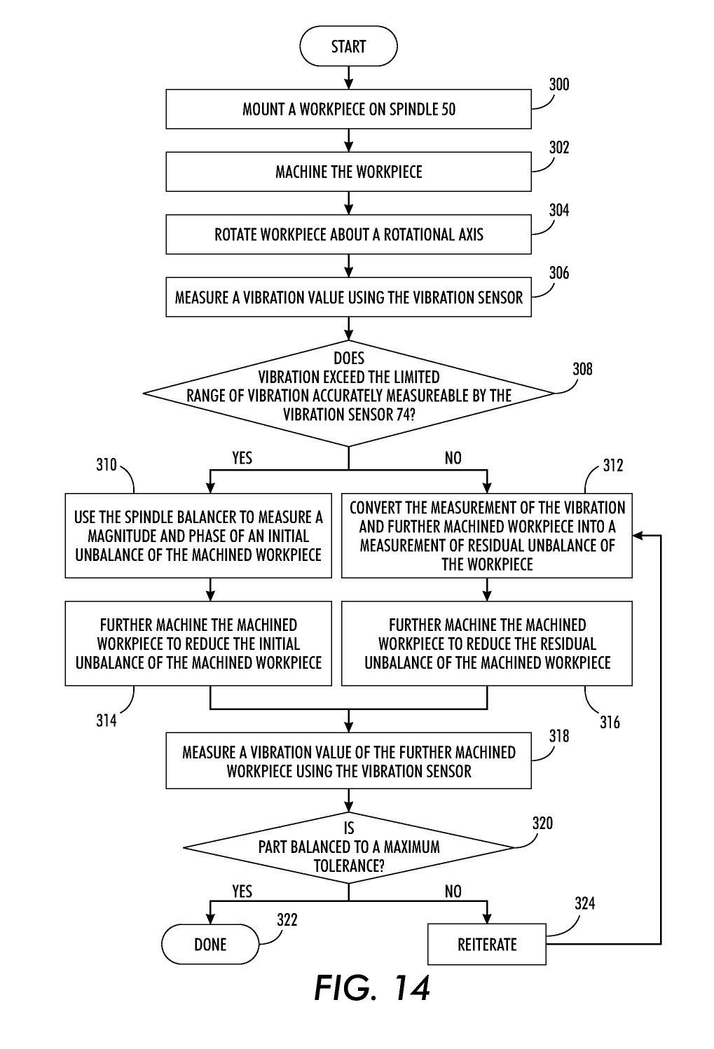

Using the established parameters, a workpiece can be balanced on a computer numerically controlled machine 100 and balancer system 54. First, without a workpiece mounted on the chuck 110, three automatic balance cycles are performed and an influence coefficient, having both a magnitude and phase, for the spindle 50 and chuck 110 is calculated as described above. The balancer system 54 is then neutralized and an initial vibration is recorded. The initial vibration value and influence coefficient are then used to calculate the unbalance in the spindle 50 and chuck 110. A balanced part is then mounted to the machine and at least three automatic balance cycles are performed at the predetermined high sensitivity speed to establish an influence coefficient for the workpiece, the spindle 50 and chuck 110 as described above. The balanced part is then removed from the chuck 110. As shown in FIG. 14, a workpiece is mounted on the chuck 110 and spindle 50 of the computer numerically controlled machine 100, shown in step 300. As depicted in step 302, the workpiece is machined on the computer numerically controlled machine 100. Then, the workpiece is rotated about a rotational axis of the spindle 50 according to step 304 and a vibration sensor 74 measures a vibration value of the spindle 50, first chuck 110 and workpiece at the predetermined preferred spindle speed, for instance 2000 rpm in the example above, according to step 306. If the vibration value is greater than the limited range of vibration magnitudes capable of being measured accurately by the vibration sensor 74, the balancer system 54 is used to measure a magnitude and phase of an initial unbalance of the machined workpiece, as depicted in steps 308 and 310. For example, if the vibration sensor 74 has a limit of 800 micro-inches, the balancer system 54 is used to measure a magnitude and phase of an initial unbalance of the machined workpiece when the vibration exceeds 800 micro-inches. If the initial vibration of the machined workpiece is less than 800 micro-inches, the initial unbalance measurement obtained from the vibration sensor 74 is used to determine the cutting parameters required to balance the workpiece, according to steps 308 and 312.

More specifically, if the magnitude and phase of the initial vibration of the workpiece, spindle 50, and the first chuck 110 is less than 800 micro-inches, then the vibration measurement is converted into a measurement of residual unbalance of the workpiece. That is, the residual unbalance of the machined workpiece is calculated by subtracting the unbalance caused by only the spindle 50 and chuck 110, from the total unbalance of the spindle 50, chuck 110 and machined workpiece.

The unbalance in the spindle 50 and chuck 110 is determined by measuring vibration without a workpiece using the vibration sensor 74 and computing the unbalance by the equation:

ME_{SC}=V_{SC}/C

where ME_{SC} is the spindle and chuck residual unbalance, V_{SC} is the vibration of the spindle 50 and the first chuck 110 measured by the vibration sensor 74, and C is the predetermined influence coefficient.

The total unbalance in the spindle 50, chuck 110, and workpiece is determined by measuring the vibration with a workpiece mounted to the spindle 50 and the chuck 110 via the vibration sensor 74, and then computing the total unbalance by the equation:

ME_{Total}=V_{Total}/C.

Therefore, the residual unbalance in the workpiece only can be computed by the following:

ME_{workpiece}=ME_{Total}−ME_{SC}

Using the unbalance value of the workpiece (ME_{workpiece}) the required removal of material can then be computed based on the equation:

L=(4/π)(ME_{Workpiece}/(D_{H}²*R_{pitch}* [symbol] ))

where L is the hole depth, ME_{workpiece} is the unbalance of the workpiece, D_{H} is the hole diameter, R_{pitch} is the pitch radius and [symbol] is the material weight density.

It should be appreciated that the pitch radius is predetermined because parts typically have a designated radius where material can be removed. The hole diameter is generally predetermined and the material weight density is known, leaving only the depth as a variable for achieving a particular balance in a workpiece. Thus, using the above equation, the location and phase of the material to be removed to balance the part is determined.

The controller 64 communicates the location and phase of the material to be removed to the computer control system 114 of the computer numerically controlled machine 100. The computer numerically controlled machine 100, accordingly, makes a cut at the desired pitch radius, depth, angle, and diameter to reduce the residual unbalance of the machined workpiece, as depicted in step 316. It should be apparent that a variety of material removal techniques can be used to make balance corrections to a workpiece, including, but not limited to milling and drilling techniques, and these removal techniques known in the art are intended to be within the spirit and scope of the invention as claimed.

The workpiece is then rotated and a vibration is measured again by the vibration sensor 74 to determine whether a maximum tolerance has been obtained, according to steps 318 and 320. If the part is balanced within the maximum tolerance, as shown in step 322, the workpiece is considered balanced. If the workpiece is not balanced within the maximum tolerance, the balancing steps described above are reiterated, according to step 324.

As stated above, if the vibration value is greater than the limited range of vibration magnitudes capable of being measured accurately by the vibration sensor 74, the balancer system 54 is used to measure a magnitude and phase of an initial unbalance of the machined workpiece, as shown in step 310. That is, the counterweight rotors 70, 72 are positioned to minimize the vibration in the system. Thus, rather than using the vibration measurement from the vibration sensor 74, the correction percentage and phase of the rotor positions 70, 72 are used to identify the system unbalance (total unbalance). The unbalance of the spindle 50 and chuck 110 is subtracted from the system unbalance and the required removal of material can then be computed based on the equation provided above. The controller 64 communicates the location and phase of the material to be removed to the computer control system 114 of the computer numerically controlled machine 100. The computer numerically controlled machine 100, according to step 314, makes a cut at the desired pitch radius, depth, angle, and diameter to reduce the initial unbalance of the machined workpiece. The workpiece is then rotated again and a vibration is measured again by the vibration sensor 74, according to step 318, to determine whether a maximum tolerance has been obtained according to step 320. If the part is balanced within the maximum tolerance, the workpiece is considered balanced, as shown in step 322. If the workpiece is not balanced within the maximum tolerance, the balancing steps described above are reiterated, as shown in step 324. It should be appreciated that using the balancer to determine unbalance of a workpiece typically provides a less accurate measurement than using the vibration from the vibration sensor 74 when the vibration is within the limited range of the sensor 74. Therefore, when using the balancer 54 to determine the location of the cut, the cutting parameters are typically more conservative, and at least a second balancing step within the limited range of the sensor 74 is typically required.

Those skilled in the art will recognize that modifications may be made in the method and apparatus described herein without departing from the true spirit and scope of the invention which accordingly are intended to be limited solely by the appended claims.

1. A method of establishing parameters of a balancer to predict part unbalance on a computer numerically controlled machine comprising the steps of:
varying unbalance of the balancer and measuring vibration to develop influence parameters of the balancer;
varying unbalance of a test part and measuring vibration to develop influence parameters of the test part;
comparing the influence parameters of the balancer with the influence parameters of the test part; and
determining a range of test part unbalance over which the influence parameters of the balancer approximately match the influence parameters of the test part.

2. The method of claim 1 further comprising a step of determining a plurality of spindle speeds within an operating range of the computer numerically controlled machine at which the spindle has a high vibration response.

3. The method of claim 2 in which the step of varying the unbalance of the balancer includes varying the unbalance of the balancer at the plurality of spindle speeds and the step of varying the unbalance of the test part includes varying the unbalance of the test part at the plurality of spindle speeds.

4. The method of claim 3 in which the step of comparing the influence parameters includes comparing the influence parameters of the balancer with the influence parameters of the test part at the plurality of spindle speeds.

5. The method of claim 4 including a step of identifying a spindle speed among the plurality of spindle speeds at which the influence parameters of the balancer better match the influence parameters of the test part.

6. The method of claim 2 in which the step of varying unbalance of a test part and measuring vibration to develop influence parameters of the test part includes making incrementally deeper cuts of known dimensions in the part and measuring vibration at the plurality of spindle speeds between each cut.

7. The method of claim 6 wherein an actual unbalance is calculated for each incrementally deeper cut using the known dimensions of the cut.

8. The method of claim 3 in which the step of varying unbalance of the balancer and measuring vibration to develop influence parameters of the balancer includes repositioning the counterweighted rotors to substantially change a vibration response.

9. The method of claim 1 in which the step of comparing the influence parameters of the balancer with the influence parameters of the test part includes comparing magnitudes and phases of influence coefficients of the balancer to magnitudes and phases of influence coefficients of the test part.

10. A method of balancing a workpiece on a computer numerically controlled machine and balancer system comprising the steps of:
mounting the workpiece on a spindle of the computer numerically controlled machine;
machining the workpiece on the computer numerically controlled machine;
rotating the workpiece about a rotational axis of the spindle;
using the spindle balancer to measure a magnitude and phase of an initial unbalance of the machined workpiece;
further machining the machined workpiece on the computer numerically controlled machine to reduce the initial unbalance of the machined workpiece;
measuring a vibration magnitude and phase of the spindle and further machined workpiece using a vibration sensor arranged for sensing a limited range of vibration magnitudes to a desired accuracy;
converting the measure of the magnitude and phase of vibration of the spindle and further machined workpiece into a measurement of magnitude and phase of a residual unbalance of the further machined workpiece; and
yet further machining the further machined workpiece on the computer numerically controlled machine to reduce the residual imbalance of the further machined workpiece.

11. The method of claim 10 in which the step of rotating the workpiece about a rotational axis of the spindle includes rotating the workpiece at a predetermined spindle speed.

12. The method of claim 11 in which the predetermined spindle speed is selected by:
rotating the spindle within an operating range of the computer numerically controlled machine;
determining a plurality of spindle speeds at which the spindle has a high vibration response;
identifying a spindle speed among the plurality of spindle speeds at which influence coefficients of the balancer are similar to influence coefficients of a test part.

13. The method of claim 10 further comprising the steps of:
measuring a vibration magnitude and phase of the spindle and machined workpiece using a vibration sensor arranged for sensing a limited range of vibration magnitudes to a desired accuracy; and
determining if the vibration magnitude and phase of the spindle and machined workpiece exceeds the limited range of the vibration sensor.

14. The method of claim 10 in which the step of converting the measure of the vibration magnitude and phase of the spindle and further machined workpiece into a measure of a magnitude and phase of a residual unbalance of the further machined workpiece includes a step of subtracting a measure of a magnitude and phase of a baseline vibration of the spindle from the measure of the vibration magnitude and phase of the spindle and further machined workpiece and dividing by a predetermined influence coefficient.

15. The method of claim 14 including a step of predetermining the influence coefficient by varying unbalance of the balancer and measuring an associated vibration.

16. A system for machining and balancing a workpiece comprising:
a computer numerically controlled machine having multiple axes for relatively moving a machining tool with respect to a workpiece;
a first computer control system operatively coupled to the computer numerically controlled machine, the first computer control system including a computer readable medium having disposed thereon code for algorithmically determining processing parameters effective for compound machining of a workpiece using a tool given a preselected processing parameter for the compound machining;
a first vibration sensor arranged for sensing a limited range of vibration magnitudes to a desired accuracy;
a rotating balancer assembly mounted between a flange and a chuck of the computer numerically controlled machine; and
the rotating balancer assembly being arranged to determine a measurement of unbalance when a first initial vibration measured by the first vibration sensor exceeds the limited range of vibration sensed by the first vibration sensor.

17. The system for machining and balancing a workpiece of claim 16, further comprising:
a second computer control system coupled to the rotating balancer assembly and the first vibration sensor to receive a first vibration signal from the first vibration sensor.

18. The system for machining and balancing a workpiece of claim 17, wherein the first computer control system communicates with the second computer control system.

19. The system for machining and balancing a workpiece of claim 18 wherein the first vibration sensor is a high sensitivity accelerometer.

20. The system for machining and balancing a workpiece of claim 19 wherein the high sensitivity accelerometer is a 1000 mV/g accelerometer.

21. The system for machining and balancing a workpiece of claim 16 further comprising a lock, wherein the lock can be enabled to prevent the rotating balancer assembly from determining a measurement of unbalance of the workpiece, and wherein the lock can be disabled to permit the rotating balancer assembly to determine a measurement of unbalance of the workpiece.
